(19) United States
(12) Patent Application Publication
(10) Pub. No.: US 2011/0147451 A1
(43) Pub. Date: Jun. 23, 2011

(54) NEAR FIELD COMMUNICATION SECURE TRANSACTIONS

(76) Inventor: Sanjay Bakshi, Portland, OR (US)

(21) Appl. No.: 12/646,428

(22) Filed: Dec. 23, 2009

(51) Int. Cl. G06F 17/00; G06K 5/00

(52) U.S. Cl. 235/379; 235/380; 235/375

(57) ABSTRACT

According to some embodiments, a method and system are provided to determine, at a portable personal computer associated with a user, a transaction between the user and a vendor to be completed via a web page, determine that a connection between the personal portable computer and a contactless payment card associated with the user has been established, and automatically facilitate a transfer of payment information from the contactless payment card to the vendor.

### BACKGROUND

Computer systems require monitoring by software programs to prevent viruses, trojans, and spyware. However, in many cases a user will neglect to update his virus/spyware detection software and his computer will become susceptible to viruses, trojans, or spyware. If the user's computer contains a virus, trojan or spyware, the user's computer may be subject to having passwords and account information stolen when the user accesses banking information or enters payment card information.

Furthermore, as more and more payment card information is compromised due to viruses, trojans, and spyware, online transactions create greater risks for online vendors. For example, when an online shopper enters in payment card information the online shopper may be entering captured payment card information and may not be a genuine holder of the payment card.

### BRIEF DESCRIPTION OF THE DRAWINGS

FIG. 1 illustrates a system according to some embodiments.

FIG. 2 illustrates a method according to some embodiments.

FIG. 3 illustrates a method according to some embodiments.

FIG. 4 illustrates a system according to some embodiments.

FIG. 5 illustrates a system according to some embodiments.

### DETAILED DESCRIPTION

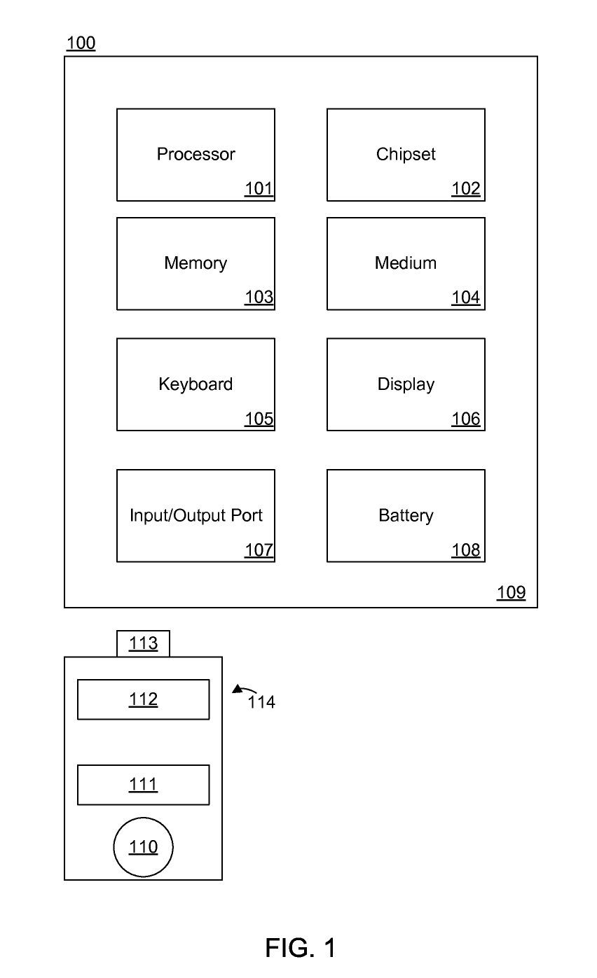

Referring now to FIG. 1, an embodiment of a system 100 is shown. The system 100 may comprise a computer system 109 and a near field communication (NFC) reader 114. The computer system 109 may comprise a processor 101, a chipset 102, memory 103, a medium 104, a keyboard 105, a display 106, an input/output port 107, and a battery 108.

The memory 103 may store, for example, applications, programs, procedures, and/or modules that store instructions to be executed. The memory 103 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

The processor 101 may include or otherwise be associated with dedicated registers, stacks, queues, etc. that are used to execute program code and/or one or more of these elements may be shared there between.

The medium 104 may comprise any computer-readable medium that may store instructions to be executed by the processor 101. For example, the medium 104 may comprise, but is not limited to, a compact disk, a digital video disk, flash memory, optical storage, random access memory, read only memory, or magnetic media.

In some embodiments, the chipset 102 may refer to a set of specialized chips on a motherboard. The chipset 202 may comprise a specific set of chips on the motherboard such as, but not limited to, a northbridge and/or a southbridge. The chipset 102 may be designed to work with the processor 101.

The battery 108 may provide power to the system 100. In some embodiments, the battery 108 may be configured to be used in a laptop or portable computing device. The keyboard 105 may comprise any device to input alphanumeric characters and/or user commands. The display 106 may display alphanumeric characters and graphics. In some embodiments, the display 106 may comprise a plurality of backlight lamps. In some embodiments, the display 106 may be a LCD display.

The input/output port 107 may comprise any port that allows peripheral devices or external elements to be connected to the computer system 109. In some embodiment, the input/output port may comprise, but is not limited to, a universal serial bus (USB) port.

The NFC reader 114 may comprise a NFC antenna 110, a NFC frontend 111, a secure element 112, and a connector 113. In some embodiments, the NFC reader 114 may be encapsulated in a dongle (i.e., a small piece of hardware that connects to a laptop or desktop computer).

The NFC reader 114 may be electrically coupled to the computer system 109 via the connector 113 that facilitates a connection to the input/output port 107. In some embodiments, the connector 113 may comprise a USB connector. However, the connector may comprise any other connector that facilitates connectivity.

The NFC antenna 110 may comprise any antenna that is, or will be, known to facilitate the exchange of data between devices over a distance. In some embodiments, the distance may comprise approximately 10 centimeters. In some embodiments, the NFC antenna 110 may comprise a loop antenna.

The NFC frontend 111 may comprise software or firmware that facilitates communication between the NFC antenna 110 and the secure element 112. In some embodiments the frontend 111 may facilitate communication between the NFC reader 114 and an NFC enabled portable communication device.

The secure element 112 may comprise one or more payment applets that facilitate communication between the NFC reader 114 and the computer system 109. Upon detection of a contactless card, the NFC frontend 111 may invoke a contactless card company specific payment applet. For example, if a user presents a contactless payment card associated with Visa within a field range of the NFC antenna 110, a Visa payWave applet may be invoked in the secure element 112. Likewise, if the user presents a contactless payment card associated with MasterCard within a field range of the NFC antenna 110, a MasterCard PayPass applet may be invoked in the secure element 112.

Furthermore, the secure element 112 may comprise a Java card operating system. The Java Card operating system may comprise one or more applets. According to some embodiments, the contactless payment card (not shown) may comprise a card in which a chip communicates with a card reader, such as NFC reader 114, through radio frequency identification (RFID) technology. A contactless payment card may require only close proximity to an antenna, such as NFC antenna 110, to complete a transaction.

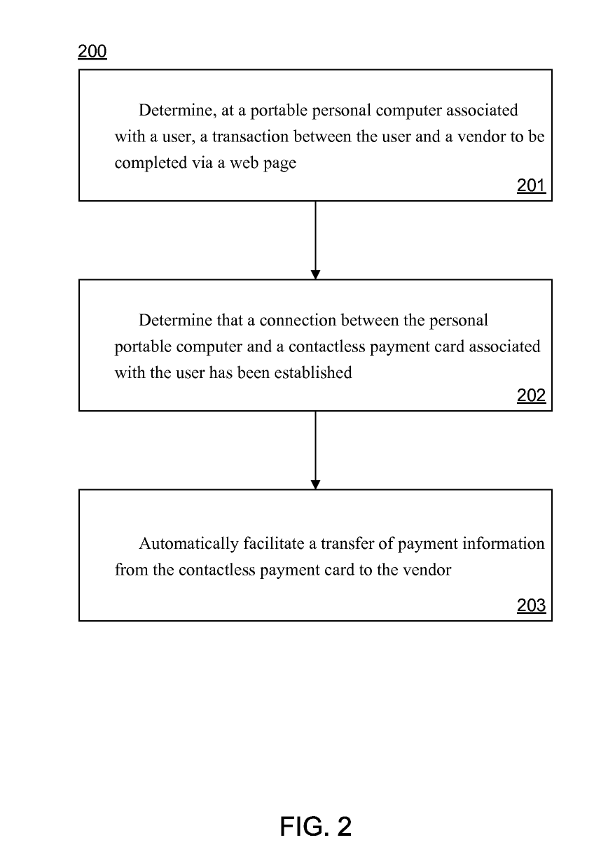

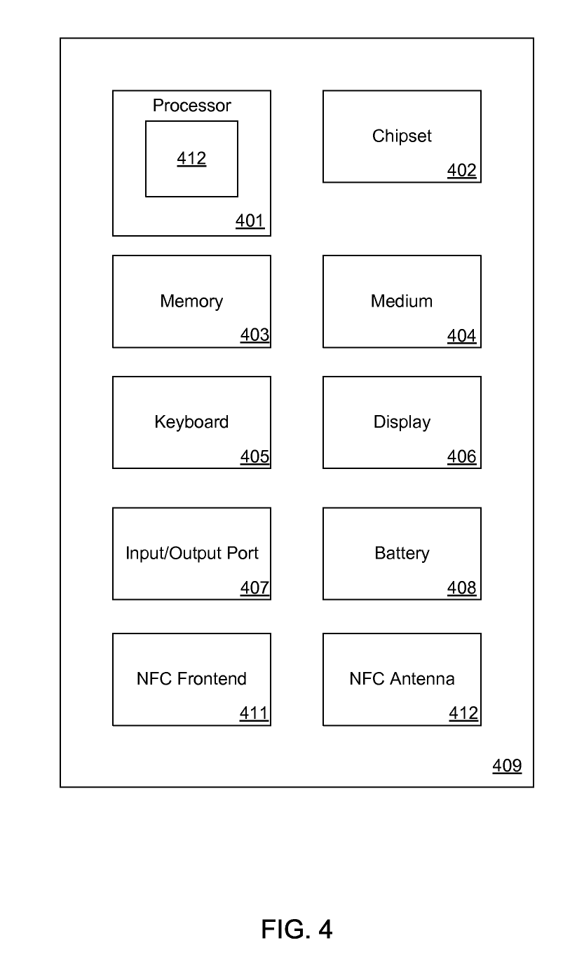

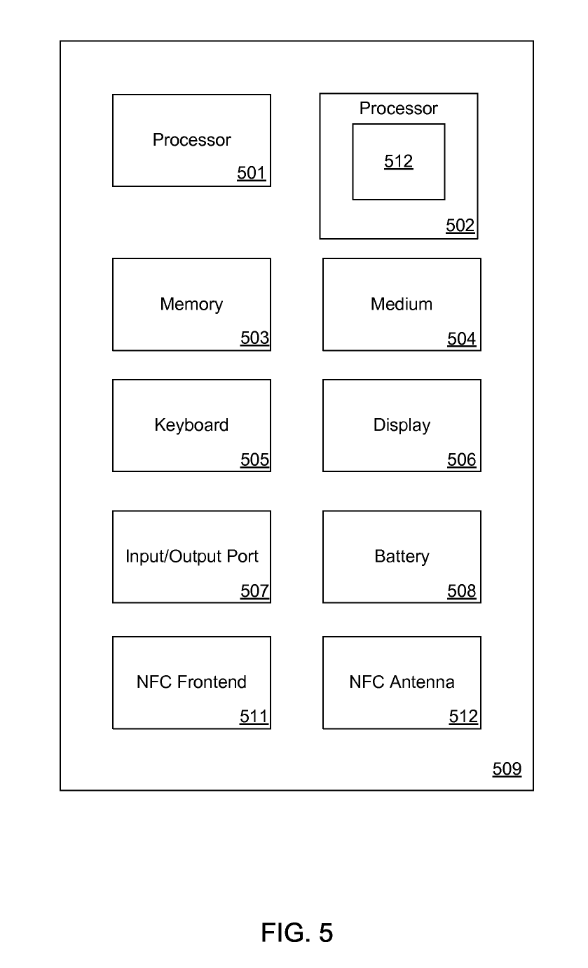

Now referring to FIG. 2, an embodiment of a method 200 is illustrated. The method 200 may be performed by a system, such as, but not limited to, the system of FIG. 1, FIG. 4, or FIG. 5. At 201, a transaction between a user and a vendor, to be completed via a web page, is determined at a portable personal computer associated with the user.

For illustrative purposes, and to aid in understanding features of the specification, an example will now be introduced. This example is not intended to limit the scope of the claims. For example, a user may shop for gifts on a shopping web page. The user may use his personal laptop computer that is connected to the Internet. The personal laptop computer may be owned by the user. When the user has completed selecting items that he wishes to purchase, the user may be prompted to check out (i.e., pay for the items he wishes to purchase).

Next, at 202, a connection between the personal portable computer and a contactless payment card associated with the user is determined to have been established. Establishing or activating a connection between the personal portable computer and a contactless payment card may comprise moving the contactless payment card in proximity to a NFC reader that is either electrically coupled to the portable personal computer or is embedded within the portable personal computer. In some embodiments, the contactless payment card may be associated with a contactless card company specific (i.e., brand specific) contactless payment card such as a Visa payWave card or a MasterCard PayPass card. In some embodiments, activating may comprise receiving an indication that the contactless payment card is in proximity to the NFC reader.

When a contactless payment card is detected at the NFC reader, the NFC reader may determine a type (i.e., associated brand) of contactless payment card and account information stored in the contactless payment card. The account information may comprise information such as, but not limited to, an account number, an expiration date, and/or a credit limit. According to some embodiments, the NFC reader may be required to have been registered with a NFC registration company, payment provider, or 3^{rd} party payment provider prior to determining a type of contactless payment card. In this embodiment, the NFC reader may determine if a registration with a NFC registration company, payment provider, or 3^{rd} party payment has been established or is valid.

In some embodiments a payment page associated with the web page may send a request to a driver associated with the NFC reader to get an authorization assertion that may be validated to approve the transaction. The assertion may be generated by an applet running on a secure element of the reader. To generate the assertion, the applet may use one or more portions of data that are read from the card. The assertion may sent by the reader to the computer system which may then forward the assertion to a backend such as a vendor or third party payment service.

The applet provided by the NFC reader may interact with a corresponding applet in a payment card to generate the authorization assertion. The authorization assertion may then be transferred to the payment page for verification.

Continuing with the above-example, the user may pay for the items he wishes to purchase by bringing his contactless payment card in proximity to the NFC reader. The applet in the NFC reader may then read information stored on the payment card and then determine a type of contactless payment card being presented and execute the transaction. In some embodiments, the computer system may establish a connection with either the contactless payment card provider or a third party to verify that the computer system (e.g., the NFC reader associated with the computer system) has been approved to handle transactions associated with the type of payment card being read by the NFC reader.

A transfer of payment information is automatically facilitated from the contactless payment card to the vendor at 203. After moving the contactless payment card in proximity to the NFC reader, information from the contactless payment card may be read by the NFC reader and transferred to the personal portable computer. The payment information stored on the contactless payment card may then be transferred from the contactless payment card to the portable personal computer via the NFC reader and the payment information stored on the contactless payment card is transferred from the portable personal computer to the vendor via a network. The network may comprise a wide area network, local area network, metropolitan area network or other network, such as an Internet protocol based network, which may electrically facilitate the transfer of data. Some embodiments of method 200 may provide assurances that a holder of a contactless payment card is a user of the contactless payment card.

In some embodiments, the reader may generate an assertion so that the vendor (e.g., a bank or merchant) can be guaranteed that a physical contactless card was presented to the reader (i.e., providing a present card guarantee). In some embodiments, applets are stored in a reader (e.g., secure element) and in a contactless card. These two applets may communicate with each other to handle the secure transaction. Furthermore, software on the computer system may indicate to the reader to power on the NFC antenna, look for a contactless card, complete a transaction with the card, and return the result along with the assertion.

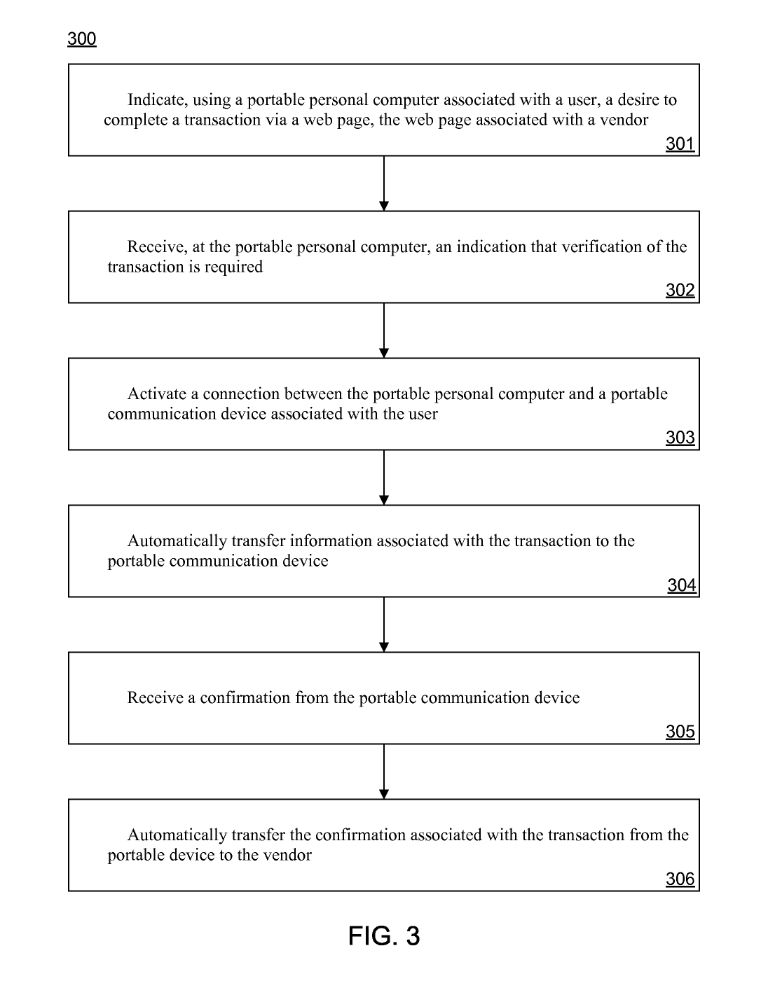

Now referring to FIG. 3, an embodiment of a method 300 is illustrated. The method 300 may be performed by a system, such as, but not limited to, the system of FIG. 1, FIG. 4, or FIG. 5.

At 301, a desire to complete a transaction, via a web page, may be indicated using a portable personal computer associated with a user where the web page is associated with a vendor. In some embodiments, the vendor may comprise a financial institution or a merchant of goods and/or services. A transaction may comprise any transaction that requires a secure or encrypted connection. For example, the transaction may comprise a transaction for a sale of an item, a sale of a service, or a bank transaction such as, but not limited to, transferring money from a first bank account to a second bank account.

For illustrative purposes, and to aid in understanding features of the specification, an example will now be introduced. This example is not intended to limit the scope of the claims. For example, a user desires to transfer $1000 from his account in Bank A to his account in Bank B. The user, via his personal laptop computer, may enter and submit the required information for the transfer of funds from Bank A to Bank B at a web page associated with Bank A.

At 302, an indication that verification of the transaction is required is received at the portable personal computer. Verification may entail that the user will acknowledge the transaction on a device other than the portable personal computer. In some embodiments, the verification may be conducted on a portable communication device that is associated with the user. The portable communication device may comprise a portable device that can transmit and receive data via NFC. For example, the portable device may comprise, but is not limited to, a personal data assistant or a cellular phone such as, but not limited to a Nokia 6131 NFC. The indication may comprise an instruction to activate a connection between the portable personal computer and the portable communication device.

Continuing with the above example, the user may receive at his personal laptop computer an indication to establish a connection with the user's cell phone and to verify the transaction.

At 303, a connection between the portable personal computer and a portable communication device associated with the user is activated. Activation may comprise bringing the portable communication device within proximity of an NFC reader that is electrically coupled or contained within the portable personal computer. When the portable communication device is within proximity of the NFC reader, the NFC reader may negotiate a connection with the portable communication device. The NFC reader may establish a connection with the portable communication device via a frontend such as that described with respect to frontend 111.

Continuing with the above example, the user may bring his cell phone towards the NFC reader until a connection is made between the cell phone and the NFC reader. Upon detection of the NFC enabled cell phone, the secure element of the NFC reader may launch an applet that establishes a connection with the NFC enabled cell phone.

At 304, information associated with the transaction is automatically transferred to the portable communication device. The information may comprise data, encryption information and/or application executables that may be executed at the portable communication device. In some embodiments, the information may comprise a transaction number and monetary amounts associated with the transaction.

In some embodiments, the portable communication device may comprise verification software that works in conjunction with the NFC reader. For example, when a connection is established between the portable personal computer and the portable communication device, a confirmation application may be launched on the portable communication device based on the received data from the portable personal computer.

When the portable communication device receives the information from the NFC reader, the portable communication device may present a verification screen to the user on a display associated with the cell phone. The verification screen may indicate a monetary amount associated with the transaction as well as indicate a source of funds and a receiver of the funds.

Continuing with the above example, after the user brings his cell phone towards the NFC reader and a connection is made between the cell phone and the NFC reader, a screen may be displayed to the user. The screen may comprise details of the transaction and may ask the user to either press a key to verify the transaction or may require the user to enter in a pre-established password to verify the transaction.

The confirmation from the portable communication device may be received, at 305. In some embodiments the user may press a key, or an area of a display to indicate that the user verifies the transaction. In some embodiments, the user may enter a pre-established password to verify the transaction. In some embodiments, the user may establish a subsequent connection with the portable personal computer by moving the portable personal device out of a range of the NFC reader and then back in range with the NFC reader. The portable communication device may transfer the confirmation to the portable personal computer where it is received.

Continuing with the above example, the user may press a key to verify the transaction or enter in a password to verify the transaction and the cell phone may transfer the confirmation to the laptop computer where it is received.

At 306, the confirmation associated with the transaction is automatically transferred from the portable device to the vendor. In some embodiments, when the user verifies the transaction, the user may have moved the portable communication device away from the NFC reader and thus out of a range of the NFC reader. In this case, the user may again move the portable communication device towards the NFC reader until a second connection is made between the portable communication device and the NFC reader. The portable communication device may then transfer verification data to the NFC reader. The verification data may comprise acknowledgment information. In some embodiments, the acknowledgement information may be encrypted. The acknowledgment information may be passed from the portable communication device to the portable computer and then from the portable computer to the vendor.

Continuing with the above example, the user may bring his cell phone towards the NFC reader until a connection is made between the cell phone and the NFC reader. Once the connection is established, acknowledgement information may be transferred from the personal communication device to the NFC Reader and then to the personal portable computer.

Now referring to FIG. 4, an embodiment of a computer system 409 is illustrated. The computer system 409 may comprise a processor 401, a chipset 402, memory 403, a medium 404, a keyboard 405, a display 406, an input/output port 407, and a battery 408. The Computer 409 may comprise an embedded NFC reader that comprises a NFC antenna 410, a NFC frontend 411, and a secure element 412. The aforementioned elements may correspond to similarly named elements of FIG. 1. As illustrated in FIG. 4, the secure element 412 may be integrated into the processor 401.

Now referring to FIG. 5, an embodiment of a computer system 509 is illustrated. The computer system 509 may comprise a processor 501, a chipset 502, memory 503, a medium 504, a keyboard 505, a display 506, an input/output port 507, and a battery 508. The Computer 509 may comprise an embedded NFC reader that comprises a NFC antenna 510, a NFC frontend 511, and a secure element 512. The aforementioned elements may correspond to similarly named elements of FIG. 1 and FIG. 4. As illustrated in FIG. 5, the secure element 412 may be integrated into the chipset 502.

Various modifications and changes may be made to the foregoing embodiments without departing from the broader spirit and scope set forth in the appended claims.

What is claimed is:

1. A method comprising:
determining, at a portable personal computer associated with a user, a transaction between the user and a vendor to be completed via a web page;
determining that a connection between the personal portable computer and a contactless payment card associated with the user has been established; and
automatically facilitating a transfer of payment information from the contactless payment card to the vendor.

2. The method of claim 1, further comprising prior to automatically facilitating a transfer of payment information:
receiving, at the portable personal computer, an indication that verification of the transaction is required;
activating a connection between the portable personal computer and a portable communication device associated with the user;
automatically transferring information associated with the transaction to the portable communication device;
receiving a confirmation from the portable device; and
automatically transferring the confirmation associated with the transaction from the portable device to the vendor.

3. The method of claim 2, wherein automatically transferring the confirmation associated with the transaction from the portable device to the vendor comprises:
generating an assertion may via an applet running on a secure element.

4. The method of claim 1, wherein activating comprises receiving an indication that the contactless payment card is in proximity to a near field communications (NFC) reader.

5. The method of claim 4, wherein the NFC reader is coupled to the portable personal computer via a universal serial bus (USB) connection.

6. The method of claim 4, wherein the NFC reader is encased within the portable computer.

7. The method of claim 6, wherein the NFC reader operates in conjunction with a security element, the security element being stored in a processor.

8. The method of claim 6, wherein the NFC reader operates in conjunction with a security element, the security element being stored in a chipset associated with a processor.

9. The method of claim 1, wherein automatically transferring payment information comprises:
receiving payment information stored on the contactless payment card from the contactless payment card to the portable personal computer via a NFC reader; and
transferring the payment information stored on the contactless payment card by the portable personal computer to the vendor via a network.

10. The method of claim 1, wherein an owner of the portable personal computer is an owner of the contact payment card, and wherein an owner of the portable personal computer is not associated with the vendor.

11. An apparatus comprising:
a medium storing instructions that when executed by a processor perform a method, the method comprising:
determining, at a portable personal computer associated with a user, a transaction between the user and a vendor to be completed via a web page;
determining that a connection between the personal portable computer and a contactless payment card associated with the user has been established; and
automatically facilitating a transfer of payment information from the contactless payment card to the vendor.

12. The apparatus of claim 11, further comprising instructions executed prior to automatically facilitating a transfer of payment information, the instructions comprising:
receiving, at the portable personal computer, an indication that verification of the transaction is required;
activating a connection between the portable personal computer and a portable communication device associated with the user;
automatically transferring information associated with the transaction to the portable communication device;
receiving a confirmation from the portable device; and
automatically transferring the confirmation associated with the transaction from the portable device to the vendor.

13. The apparatus of claim 12, wherein automatically transferring the confirmation associated with the transaction from the portable device to the vendor comprises:
generating an assertion may via an applet running on a secure element.

14. The apparatus of claim 11, wherein activating comprises receiving an indication that the contactless payment card is in proximity to a near field communications (NFC) reader.

15. The apparatus of claim 14, wherein the NFC reader is encased within the portable computer.

16. The apparatus of claim 14, wherein the NFC reader operates in conjunction with a security element, the security element being stored in a processor.

17. The apparatus of claim 14, wherein the NFC reader operates in conjunction with a security element, the security element being stored in a chipset associated with a processor.

18. A system comprising:
a display;
a processor;
a near field communications (NFC) reader;
a battery to power the display, the processor, and the NFC reader; and
a medium storing instructions that when executed by the processor perform a method, the method comprising:
determining, at a portable personal computer associated with a user, a transaction between the user and a vendor to be completed via a web page;
determining that a connection between the personal portable computer and a contactless payment card associated with the user has been established; and
automatically facilitating a transfer of payment information from the contactless payment card to the vendor.

19. The system of claim 18, further comprising instructions executed prior to automatically facilitating a transfer of payment information, the instructions comprising:
receiving, at the portable personal computer, an indication that verification of the transaction is required;
activating a connection between the portable personal computer and a portable communication device associated with the user;
automatically transferring information associated with the transaction to the portable communication device;
receiving a confirmation from the portable device; and
automatically transferring the confirmation associated with the transaction from the portable device to the vendor.

20. The system of claim 18, wherein automatically facilitating a transfer of payment information comprises moving the contactless payment card in proximity to the NFC reader.
